(19) United States
(12) Patent Application Publication
(10) Pub. No.: US 2014/0281011 A1
(43) Pub. Date: Sep. 18, 2014

(54) SYSTEM AND METHOD FOR REPLICATING A MEDIA STREAM

(71) Applicant: WATCHITOO, INC., New York, NY (US)

(72) Inventor: Rony ZAROM, New York, NY (US)

(73) Assignee: WATCHITOO, INC., New York, NY (US)

(21) Appl. No.: 14/213,757

(22) Filed: Mar. 14, 2014

Related U.S. Application Data
(60) Provisional application No. 61/793,484, filed on Mar. 15, 2013.

(51) Int. Cl. H04L 29/06

(52) U.S. Cl. CPC H04L 65/602
USPC 709/231

(57) ABSTRACT

A system and method allows for simultaneous generation of a dual output stream—a first for real-time broadcast with relatively lower quality for faster transmission, and a second for later rebroadcast with significantly improved quality relative to the first stream, both having the same content. During the real-time broadcast, the recorded content may be edited, and an edit-log may record the specific segments from the multiple sources that are used in the broadcast. The lower quality stream may be transmitted with priority for immediate viewing, while the higher quality stream is initially stored locally and only transmitted later or at a lower priority over bandwidth not otherwise needed for the first stream. Once bandwidth is available, the higher quality stream source data may be edited locally or transmitted to a remote server for remote editing where they are compiled to replicate the original broadcast, but with significantly improved quality.

### CROSS-REFERENCE TO RELATED APPLICATIONS

This application claims the benefit of U.S. Provisional Patent Application No. 61/793,484, filed Mar. 15, 2013, which is incorporated by reference in its entirety.

### BACKGROUND OF THE INVENTION

In network broadcasting, a broadcast provider may transmit data to viewers over a network, such as, the Internet. The rate of data transmission is generally limited by the network's available bandwidth. To effectively transmit data within this limited bandwidth, broadcast providers may balance the quality and streaming speed of the transmitted data. For example, broadcasts transmitted at relatively high quality (demanding more bandwidth) typically have relatively slow streaming speeds, while broadcasts transmitted at relatively low quality (demanding less bandwidth) typically have relatively fast streaming speeds.

In “real-time” broadcasting, streaming speed is paramount, and broadcasts typically have a streaming speed equal to at least the speed of the recording to simulate real-time viewing. However, to compensate for such fast streaming speeds, the quality of the data is typically degraded causing low-quality broadcasts.

### BRIEF DESCRIPTION OF THE DRAWINGS

The subject matter regarded as the invention is particularly pointed out and distinctly claimed in the concluding portion of this specification. Specific embodiments of the present invention, both as to organization and method of operation, together with objects, features, and advantages thereof, will be described and may best be understood with reference to the following detailed description when read with the accompanying drawings, wherein:

FIG. 1 is a schematic illustration of a dual-mode broadcast system in accordance with an embodiment of the invention;

FIG. 2 is a schematic illustration of dual paths of data in a dual-mode broadcast system in accordance with an embodiment of the invention; and

FIG. 3 is a flowchart of a method for replicating a broadcast in a dual-mode broadcast system in accordance with an embodiment of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY OF THE INVENTION

The invention provides a system and method for recording a dual output stream—a first for real-time broadcast with relatively low quality, and a second for later rebroadcast with significantly improved quality relative to the first stream. The first output stream is recorded at, or converted to, relatively low quality for relatively fast transmission speed, in order to provide real-time viewing, e.g., over a wireless or high traffic channel. A second output stream is also recorded at, or converted to, relatively high quality in a local storage for relatively slow transmission speed, in order to provide high quality viewing, e.g., generally not in real time. The first and second streams may be recorded or generated simultaneously and may record the same exact content, but with different quality; the second stream having better quality (preferable for high quality viewing) but requiring more memory than the first stream (preferable for real-time viewing). The first, lower quality stream may be transmitted with higher priority for immediate viewing (e.g., in real-time during the recording period), while the second, higher quality stream is initially stored locally (during the recording period) and only transmitted later (after the recording period) or may be transmitted at the same time but with lower priority, e.g., over bandwidth not otherwise needed for the first stream.

During the real-time broadcast, the recorded content may be edited in real-time. In one embodiment, an editing display may have multiple windows with lower quality stream content recorded from multiple sources, which may be edited, e.g., with other fast streams or alone, to provide the final lower quality stream broadcast. An edit-log may record the specific segments from the multiple sources that are used in the real-time, fast stream broadcast. Once bandwidth is available (e.g., after the real-time broadcast has been completed), the higher quality stream source data may be edited locally or transmitted to a remote server for remote editing where they are compiled to replicate the original broadcast. The segments of the higher quality stream identified in the edit-log are assembled in the same manner as they were in the original lower quality stream broadcast so as to replicate the real-time broadcast, but with the improved quality recorded with the higher quality stream. The result is an exact or substantial replica of the real-time final edited broadcast, which is only available at a time delay after the real-time broadcast, but with significantly improved quality.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

“Broadcast” may mean any display, stream, playback or presentation of content in any medium, such as, image, videos, multi-media, audio, text, graphics, etc. Broadcasts may be provided via any public or private media channel, for example, a wired or wireless channel or network such as the Internet, television, closed-circuit television, radio, on a user's computer, etc. Broadcasts may be displayed on any output device, such as a television screen, personal computer monitor, wireless device monitor, cellular phone monitor, tablet computer monitor, radio player, etc. Broadcasts may use any personal or collaborative viewing platform including web-based seminars (webinars), synchronized media displays for a collection of viewers, etc. In some embodiments herein, Internet broadcast is described as an example and may refer to any other type of broadcast of streaming display.

Broadcasts may be edited as a plurality of different segments from a plurality of different media streams generated at a plurality of different recording devices or other sources. Each media stream segment may include content or media objects, such as, for example, images, videos, audio tracks, text streams, social media or chat streams, webpages, applications, advertisements, etc. Multiple media stream segments may be assembled to create a broadcast, e.g., a single stream or multiple streams, each with a combination of the media objects. For example, a multi-frame broadcast may simultaneously display, in different windows, segments from a plurality of data streams received by a plurality of respective recording devices. Broadcasts may also include a plurality of design parameters, such as, layouts, themes, backgrounds and layer arrangements.

Current network broadcasting systems present a trade-off between quality and streaming speed, but cannot reliably provide both high quality and fast streaming speed at current bandwidth capacities. To meet available bandwidth capacities, relatively high-quality broadcasts typically have relatively slow streaming speeds, while relatively fast streaming broadcasts typically have relatively poor quality.

In order to improve network broadcasting, embodiments of the invention provide the advantages of both high quality and fast streaming speed in a dual-mode broadcast system. The dual-mode broadcast system splits broadcasting into two paths: a first, “fast” path for optimizing speed for real-time viewing, and a second, “slow” or “quality” path for optimizing the viewing quality. In the “fast” path, broadcast content may be recorded as a “fast” data stream with relatively low quality for fast streaming speed. In the “quality” path, the broadcast data content may be recorded as a “slow” data stream with relatively high quality in a local storage for later viewing. The fast and slow streams record the same exact content, but with different quality. The slow stream may have better quality (preferable for high quality viewing), but typically requires more memory than the fast stream (preferable for real-time viewing). The fast stream may be transmitted with higher priority for immediate viewing, while the slow stream is initially stored locally, e.g., at the recorder, and only transmitted over the broadcast network at a later time, for example, after the full length real-time broadcast is completely transmitted, or at the same time but with lower bandwidth priority, or later, when the network bandwidth is available.

In one embodiment, the two data streams are transmitted simultaneously, but with different priorities. The first, lower quality data stream has a higher priority than the second, higher quality data stream and is allocated as large a portion of the available bandwidth as is necessary to transmit the first, lower quality data stream at its full, unrestricted speed and resolution. In some examples, the portion of available bandwidth allocated to the first, lower quality data stream is larger (for example, a greater rate of packet transmission) than the portion allocated to the second, higher quality data stream. In some examples, the portion of available bandwidth allocated to the first, lower quality data stream is smaller than the portion allocated to the second, higher quality data stream, as long as the first, lower quality data stream is transmitted at a higher proportion of its full, unrestricted transfer rate and resolution.

The two streams may be transmitted to the same or different devices.

During the real-time broadcast, the fast, i.e., lower quality or higher priority, stream may be edited, e.g., with other fast streams or alone. For example, the real-time broadcast may be a composite of video segments from multiple video, radio or other media sources interplayed in an edited (non-chronological) order selected by an editor. An edit-log or the edited stream itself may catalogue or index the edited order of the segments of the fast stream used in the real-time broadcast. The edit-log may be generated by editing the streams remotely, e.g., at the same device or terminal as the recording devices, and/or centrally, e.g., at a central server.

After the real-time broadcast, the slow, i.e., higher quality or lower priority, stream may be transmitted to a remote server where the slow stream may be edited to replicate the real-time broadcast of the fast stream. When the broadcast is edited using content recorded at multiple remote sources, all the slow streams from each source may be synchronized, e.g., at a central server, by their time stamps for editing. Once synchronized, segments of the slow streams identified in the edit-log, e.g., by their stream source and time-stamp, may be assembled to replicate the real-time broadcast, but with the improved quality recorded with the slow streams. The result is an exact replica of the real-time broadcast, which is only generated at a time delay after the real-time broadcast, but has significantly improved quality.

In one embodiment, the dual-mode broadcast may be turned on or off, for example, automatically activated when network traffic is substantially high, when available bandwidth is below a threshold rate, or after attempting and failing to transfer data using the relatively high quality second stream, and automatically deactivated otherwise. In another embodiment, the dual-mode broadcast may toggle between broadcasting relatively higher and lower quality frames or segments as the available network bandwidth oscillates, for example, transferring higher quality content when network traffic or bandwidth permits it, and transferring lower quality content when network traffic or bandwidth does not permit it.

In another embodiment, the dual-mode broadcast may be customized such that the output resolution and/or frame rate of the first, i.e., lower quality or higher priority, data stream from each recording device(s) is selected as desired, e.g., in advance of transmission. In a further embodiment, the dual-mode broadcast may be customized such that the output resolution and/or frame rate of the first data stream from each recording device(s) dynamically changes during its recording or transmission so as to fit within the available bandwidth or within the bandwidth assigned for high priority data transmissions.

Although some embodiments of the invention describe broadcasting media in an Internet, television, radio or other broadcast display, it may be appreciated that such embodiments of the invention may similarly be used for any other type of display, including, for example, newspaper or magazine layout, text or multi-media layout, combining different streams or media sources, or any other system and method for designing and displaying media objects.

Reference is made to FIG. 1, which schematically illustrates a dual-mode broadcast system 100 in accordance with an embodiment of the invention. Dual-mode broadcast system 100 may provide two duplicate broadcasts: a first real-time broadcast with relatively lower quality and a second postponed broadcast that has content substantially identical to that of the first broadcast, but with relatively higher quality. For example, the first and second broadcasts may include the same sequence of frames. Alternatively, in order to accommodate higher capture rates, the second stream may include the frames of the first stream as well as additional frames not included in the first stream.

Dual-mode broadcast system 100 may include a plurality of recording devices 102 for capturing content used in system 100 broadcasts. Recording devices 102 may include, for example, video recorders, cameras, web-cams, microphones, telephones, etc., and may record any media types, such as, video, audio, multi-media, etc. Each recording device 102 may have a local processor 106, e.g., to execute commands received from broadcast server 120 (either directly or via a broadcast client installed locally on recording device 102), and/or a local memory 108, e.g., to locally store its recorded content.

Each recording device 102 may create two streams of duplicate content for each recording. The first stream may have a relatively fast streaming speed and relatively low quality, e.g., for use in the first real-time broadcast, and the second stream may have a relatively slow streaming speed and high quality, e.g., for use in the second, postponed or simultaneous but lower priority (e.g., lower proportion of bandwidth), high-quality broadcast. Additional third or more streams of differing quality may also be used for a third or more duplicate broadcasts to be replicated with different qualities. In one example, different playback devices may have different specific resolution or quality requirements, each of which may be generated and sent for playback to the different respective devices. The first and second streams of the same recording device 102 may record the exact same or substantially identical content and may be indexed by the same sequence of time-stamps or other identifiers. Due to the relatively higher quality, the second stream may have a significantly greater data size than the first stream of each recording device 102. Duplicate recording by recording devices 102 may be controlled or initiated by server-side logic and data installed at broadcast server 120 via remote commands to recording device 102 or by client-side logic and data installed at recording device 102 as an application, plug-in, software or code.

Each recording device 102 may transmit the first (fast, e.g., real-time, or higher priority) stream automatically, immediately and/or in real-time, to the remote broadcast server 120, e.g., over network 140, and may withhold and store the second (slow) stream locally, e.g., in memory 108, for later transmission. Transmitting the first stream may be almost instantaneous, e.g., delayed by at most a few seconds or minutes of recording, while transmitting the second data stream may take a significant amount of time, e.g., one to two hours (the exact times depending on data size and available bandwidth). Since the data size of the second data stream is substantially greater than the first data stream, network 140 traffic may be minimized by postponing transmission of the larger second data stream, e.g., at least until after the entire smaller first data stream is transmitted, or simultaneously or at overlapping time periods, but with a lower bandwidth priority. The first and second data streams may be transmitted over any type of communication channel, such as, for example, cable connections, ISDN, DSL, or wireless connections such as Wi-Fi, satellite or cellular such as GSM, W-CDMA, GPRS, EDGE, etc. The first and second data streams may be transmitted over the same or different communication channels, e.g., the first data stream may be transmitted over a relatively faster communication channel than the second data stream.

Broadcast server 120 may host an editing interface for an editing device 110 to edit the first (real-time) set of data streams to generate a first (real-time) version of a broadcast. Since data from the first set of data streams is available to editing device 110 in real-time, and data from the second set of data streams is reserved for later use, the broadcast creator may edit data only from the first (fast or real-time) data streams, not from the second (slow or high-quality data) data streams.

The interactive design interface may present the editor with a set of different first (real-time) data streams, each captured or generated by a different recording device 102 with relatively faster streaming speed and lower quality. Each stream may be visualized as a video thumbnail and may be viewed live, as it is recorded, from each of selected recording device 102, or, at a slight time delay thereof, for example, at most ten to twenty minutes. The set of first data streams may be synchronized for editing by synchronizing the respective time stamps of the first data streams.

A broadcast creator or editor may operate editing device 110 to design the broadcast by selecting a combination of frames or segments from two or more of the plurality of first streams, composed in an edited, selected and/or non-chronological order. The editor may edit by manipulating and controlling an interactive design interface to create a simulation of the broadcast on the moderator screen. The design interface may function as a staging area, or “green room”, which may mimic the broadcast screen. Broadcast server 120 may automatically transcribe the editor's selections to generate a first (real-time) version of the edited broadcast. For example, if the editor drags a data stream's thumbnail to a primary (front) window in the broadcast simulation at a particular time, a set of edit parameter values may be automatically created corresponding to that edit, for example, (data stream identification (ID), timestamp 1:15, layout design, window 1). Edit parameters for broadcasting a data segment may include, for example, the segment's input data stream ID, a timestamp of the input data stream when the segment starts, ends and/or the segment length, a timestamp when the segment is to be displayed in the broadcast, a layout design or theme for displaying that segment, the display window or spatial position within the layout design for displaying that segment, display size or dimensions (e.g., number or positions of pixels, and pixels×pixels) of the segment viewing window, layer order, coloring or transparency for displaying that segment, segment run-time, etc.

Each edited broadcast may be defined by an edit-log cataloging the one or more edit parameters, including the stream segment time-stamps defining the ordering and timing of broadcasting each edited segment. For example, a broadcast may be defined by an edit-log including the following portion: {. . . timestamp 1:15, stream 3, layout A, front window; timestamp 1:25, stream 2, layout A, side window 3; timestamp 2:43, stream 5, layout B, front window; . . . }. The edit-log together with only the set of input data streams from recording devices 102 (either the first or second sets) may be used to fully create the edited broadcast (either a first or second version, respectively). In the example above, the broadcast may be a multi-frame broadcast having multiple windows (e.g., a front window, three or more side windows 1-3, etc.) for simultaneously displaying segments from a plurality of data streams received by a plurality of respective recording devices 120. A single window broadcast may also be used, displaying at most one data stream segment in each broadcast time interval.

Broadcasts may be edited and designed in real-time. For example, as the moderator selects stream segments to be displayed and/or selects an “on-air” feature, these stream segments may be transmitted automatically instantaneously to one or more viewer devices 104. In another embodiment, real-time editing need not be executed instantaneously and instead, may first be designed and edited in an “off-air” mode in a staging area and then, once finalized, may be implemented when an “on-air” signal is sent. It may be appreciated that real-time editing and broadcasting need not be instantaneous and may include slight delays of, for example, up to ten or twenty minutes.

Broadcast server 120 may transmit the first (real-time) version of the edited broadcast to one or more viewer devices 104. In one embodiment, the first version of the edited broadcast may be assembled at broadcast server 120 and transmitted as a single data stream to viewer devices 104. In another embodiment, broadcast server 120 may transmit each consecutive broadcast segment separately, in pieces, according to the sequence ordering in the edit-log, and viewer devices 104 may assemble the broadcast locally at the remote client-side. In another example, the central broadcast server 120 may simply transmit the edit log to viewer devices 104, where viewer devices 104 may download segments according to the edit-log directly from the broadcast content storage, e.g., database 130 or memory unit 124.

Viewer devices 104 may display the first version of the broadcast in real-time (immediately or in the next available broadcast slot(s)), e.g., synchronized, on all devices subscribed and/or connected to broadcast server 120 via network 140. Viewer devices 104 may include, for example, television screens, personal computer monitors, wireless device monitors, cellular phone monitors, tablet computer monitors, radio players, electronic billboards, or any output device capable of displaying the broadcast media.

The first version of the edited broadcast may have a desirable streaming speed, e.g., greater than or equal to the streaming speed of the first input data streams (a greater streaming speed achieved by further compression of the input data), suitable for real-time viewing. However, the quality of the first version of the broadcast may be relatively low, e.g., less than or equal to the quality of the first input data streams (a lesser quality achieved by further compression of the input data). To improve such low quality, embodiments of the invention may turn to the other “higher-quality” data path in the dual-mode broadcast system 100 to create a second higher quality version of the broadcast using the second set of input data streams stored locally at their respective source recording devices 102.

The second (high-quality) input data streams may be transferred (e.g., after transferring all the first input data streams or at a lower transmission priority) from local storage 108 in recording devices 102 over network 140 to memory unit 124 in broadcast server 120 or its associated database 130. The second set of data streams may be transferred over a secure network 140 platform, e.g., Transmission Control Protocol (TCP)/Internet Protocol (IP), which acknowledges receipt of transmissions to ensure all data is properly transferred. Broadcast server 120 may assemble the second set of input data into the second version of the broadcast using the same edit-log used to generate the first (lower quality) version of the broadcast. Since the same edit-log is used to edit the same exact content in the first and second sets of data streams, the first and second versions of the broadcast should have exactly the same or substantially identical context, but with different quality. The second version of the broadcast, available only at a time delay, e.g., after all the first data streams are transferred, provides a significant improvement in viewing quality. In one embodiment, the first version of the broadcast may be displayed only once for an initial real-time showing (or not at all if not requested), and the second versions of the broadcast may be displayed for every subsequent viewing at viewing devices 104.

Although the functionality of the dual-mode broadcast system 100 is attributed to broadcast server 120, equivalently such functionality may be implemented on recording device 102 and/or editing device 110 via logic and data installed in the client device as an application, plug-in, software or code, or may be streamed together with logic and data commands.

Recording devices 102, viewing devices 104, editing device 110 and broadcast server 120, may include one or more processor(s) 106, 116, 112 and 122, respectively, for executing operations and one or more memory unit(s) 108, 118, 114 and 124, respectively, for storing data and/or instructions (e.g., software) executable by a processor. Processor(s) 106, 116, 112 and/or 122 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 108, 118, 114 and/or 124 may include, for example, a random access memory (RAM), a dynamic RAM (DRAM), a flash memory, a volatile memory, a non-volatile memory, a long-term memory unit, a short-term memory unit, a cache memory, a buffer, or other suitable memory units or storage units. In FIG. 2, memory unit(s) 108a, 118a and 124a may be short-term memory units, while memory unit(s) 108b, 118b and 124b may be long-term memory units (although any other type(s) of memory units may be used).

Reference is made to FIG. 2, which schematically illustrates dual paths or modes of data in the dual-mode broadcast system 100 of FIG. 1 in accordance with an embodiment of the invention. In FIG. 2, duplicate (identical) content is transmitted in dual (“first” and “second”) paths with different data qualities. For example, the first path represents the content at a relatively low quality and fast streaming speed and the second path represents the same content at a relatively high quality and slow streaming speed. Although FIG. 2 shows the dual path or modes of data from a single recording device 102 and to a single viewing device 104, it may be appreciated that these paths are replicated for each additional recording device 102 and/or viewing device 104. In addition, additional versions of broadcasts may be generated using additional data paths, e.g., of up to three, four, . . . , n versions.

Recording device 102 may record or generate content at an initial (high) quality and store the content, in duplicate, as a low quality version 126 used in accordance with the first path and a high quality version 128 used in accordance with the second path. The higher quality version may have a higher resolution and higher display frame rate than the lower quality version.

In the first path, low quality version 126 may be scheduled for immediate transmission from recording device 102 to broadcast server 120 (between buffers, caches or other short-term or internal processor memories 108a and 124a, respectively) as the data is recorded or generated. Using the low quality version 126, a first version of a broadcast 132 (and/or an edit-log 134 associated with the broadcast) may be generated, e.g., via editing device 110, to include segments of low quality version 126. First version of the broadcast 132 (and/or an edit log 134) may be transmitted to viewing device 104 and displayed, e.g., in real-time, on a monitor or screen 138.

Recording device 102 may transmit the entire low quality version 126 in the first path during the data stream recording and, upon completion of the recording, may switch to the second to transmit high quality version 128.

In the second path, recording device 102 may store high quality version 128 in a long-term memory 108b while its content is being recorded or generated. Once the recording is ended and low quality version 126 is completely transmitted, recording device 102 may compress, encrypt and/or transmit high quality version 128. High quality version 128 may be transmitted from long-term memory 108b in recording device 102 to a long-term memory 124b in broadcast server 120. High quality version 128 may be transmitted over a network protocol (e.g., TCP/IP) that is more secure than is used to transmit low quality version 126; alternatively, the same network protocol may be used. Once high quality version 128 is completely transferred to broadcast server 120, edit log 134 may already be generated, and processor 122 may begin to edit high quality version 128 according to edit log 134 to generate a second version of the broadcast 136. High quality version 128 may be transmitted in whole, or in part including only the segments or frames identified by edit-log, so as to reduce the amount of transferred data.

Second version of the broadcast 136 may be assembled into a single stream by processor 122 at broadcast server 120 and may be transmitted to viewing device 104, e.g., in consecutive data packets, according to the stream sequence. Alternatively, broadcast server 120 may transmit unassembled segments identified in edit log 134 (e.g., along with edit log 134) to viewing device 104 to be assembled by processor 116 into second version of the broadcast 136. Second version of the broadcast 136 may be identical in content, but having higher quality, validity, resolution, reliability, and/or security than first version of the broadcast 132. Viewing device 104 may display second version of the broadcast 136 on a monitor or screen 138, e.g., upon request by or establishing a connection with a subscribing user device. All instances of first version of the broadcast 132 may be automatically updated and replaces with second version of the broadcast 136, for example, for improved quality viewing.

Reference is made to FIG. 3, which is a flowchart of a method 300 for replicating a broadcast in a dual-mode broadcast system in accordance with an embodiment of the invention. Method 300 may be executed using the device components of the dual-mode broadcast system of FIG. 1, such as, server-side components, e.g., broadcast server 120, or client-side components, e.g., recording device 102 and/or editing device 110 operating logic and data installed or received as an application, plug-in, software, code or command.

In operation 310, a processor (e.g., processor 122 of broadcast server 120 of FIG. 1) may receive a first version of the data stream (e.g., low quality version 126 of FIG. 2) from a device (e.g., recording device 102 of FIG. 1) over a network (e.g., network 140 of FIG. 1). The device may generate two or more duplicate versions of a data stream that have the same content and different quality (e.g., low and high quality versions 126 and 128 of FIG. 2). The first version of the data stream (e.g., low quality version 126 of FIG. 2) may have a relatively lower quality than the second version of the data stream (e.g., higher quality version 128 of FIG. 2). The processor may repeat operation 310 to receive the first (relatively lower quality) version of the data stream from each of a plurality of the devices.

In operation 320, the processor may edit the first version of one or more data streams, each received from one of the plurality of devices to generate a first version of an edited broadcast. Editing may include automatically transcribing editing instructions received from a client editing device (e.g., editing device 110 of FIG. 1) to generate an edit-log (e.g., edit log 134 of FIG. 2) indexing timestamps of segments of the data streams to be included in the edited broadcast. Since the first version of the edited broadcast is edited using only the first versions of the data streams, the first version of the edited broadcast may have a quality equal to the relatively lower quality of the first versions of the data streams (or less than that quality, if further compressed). After the complete first versions of the data streams are received, a process or processor may proceed to operation 330 when editing is complete and/or operation 340 when network traffic is available (in either order).

In operation 330, one or more display(s) (e.g., monitor(s) 138 of viewing device(s) 104 of FIG. 1) may each display the first version of the edited broadcast, for example, in real-time.

In operation 340, the processor may receive a second version of one or more same data streams (e.g., high quality version 128 of FIG. 2), each with a relatively higher quality than the first versions of the data streams, from the same device over the network. Receiving the second versions of the data streams (operation 340) is postponed until after the entire first versions of the data streams are received (operation 310) to increase the network traffic available for receiving the first versions of the data streams to maximize the speed of displaying the first version of the edited broadcast (operation 330) edited based thereon (operation 320). In another embodiment, the second versions of the data streams may be sent at the same time as the first versions of the date stream but with lower bandwidth priority or with a lower proportion of its associated high quality transmission rate. The processor may receive the second versions of the data streams using a network protocol (e.g., TCP/IP) that is relatively more secure than that used to receive the first version of the data stream; alternatively the same protocol may be used for receiving both versions.

In operation 350, a processor (e.g., a server-side processor 122 at broadcast server 120 or a client-side processor 116 at viewing device 104 of FIG. 1) may generate a second version of the edited broadcast replicating the first version of the edited broadcast. The second version of the edited broadcast may be available for viewing only at a time delay after the first version of the edited broadcast, but with the relatively higher quality.

In operation 360, the processor may automatically replace (all or some) instances of the first version of the edited broadcast with the second version of the edited broadcast and/or transfer the second version of the edited broadcast to a viewing device (e.g., viewing device 104 of FIG. 1) for display. For example, if a server-side processor (e.g., processor 122 of FIG. 1) generates and stores the second versions of the data streams and/or the edited broadcast at the server-side (e.g., in database 130 of FIG. 1), the processor may simply replace those first versions with second versions. However, if a client-side processor (e.g., processor 116 of FIG. 1) generates and stores the second versions of the data streams and/or the edited broadcast at the client-side (e.g., in memory unit 118 of FIG. 1), the server-side processor may send updates to each of the client-side devices to update the versions from the first to the second. The edit-log need not be replaced or updated to improve quality (it is compatible with both the first and second versions of the data streams and edited broadcasts), but may in some embodiments be replaced or updated if the edited broadcast was further edited to generate a new or modified edited broadcast.

In operation 370, the display(s) may display the second version of the edited broadcast at a time postponed from when the first version of the broadcast is available for viewing.

Other operations of orders of operations may be used.

It may be appreciated that the terms “high” or “low” quality and “fast” or “slow” streaming speed are relative terms and are described in reference to each other. For example, the streaming speed of the first recorded stream or broadcast is faster relative to the streaming speed of the second recorded stream or broadcast and the quality of the second recorded stream or broadcast is greater (e.g., higher resolution or storing more data per frame) than the quality of the first recorded stream or broadcast.

The “quality” of media content may refer to the image resolution (e.g., the number or density of pixels or pixel rows and/or columns), the rate of data transfer necessary to support media playback at those resolutions, and/or a capture or playback rate of the media (e.g., the number of frames per second (fps)). In some embodiments, these terms may be defined independently, e.g., associated with value ranges. For example, “low-definition” (LD) broadcasts may have a resolution of, e.g., less than 300×400 pixel ratio, which is relatively lower quality than “standard-definition” (SD) broadcasts that may have a resolution of, e.g., 640-480 pixel ratio, which in turn is relatively lower quality than “high-definition” (HD) broadcasts that may have a resolution of, e.g., 1080×720 pixel ratio, which in turn is relatively lower quality than “ultra high-definition” (UHD) broadcasts that may have a resolution of, e.g., 3840×2160 pixels. To support playback at these image resolutions, a “high” quality broadcast stream at present technological standards may include high quality, e.g., high definition, image detail, such as a data transfer rate of 2-3 mbps (megabits per second) or greater playback quality, preferably approximately 2.5 mbps, or up to 4 mbps or greater. In addition, for example, a “low” quality stream at present technological standards may include low quality or definition image detail having a data transfer rate of 30-100 kbps (kilobits per second), or less than 800 kbps, depending upon the bandwidth of the uplink.

For example, a “fast” streaming speed may refer to the speed of transmissions that are prioritized or queued to be sent before data transmissions sent at a “slow” streaming speed. The exact speeds depend on the quality discussed above, available bandwidth and other competing transmissions.

It should be appreciated that the speed discussed herein may refer to the speed at which data can stream, not the speed of transmission or the speed of the memory or processor to process the data. It may be appreciated that different versions having “substantially” the same content means that the versions have primarily the same content but allows for minor variations due to errors in transmission, decryption, etc. It may be appreciated that different versions having “substantially” different quality may mean that the quality has a great enough difference to be visibly noticeable to the human eye.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller (e.g., processor 106, 116, and/or 122 of FIG. 1), cause the processor or controller to carry out methods disclosed herein.

Various embodiments are discussed herein, with various features. However, not all features discussed herein must be in all embodiments. Furthermore, features of certain embodiments may be combined with features of other embodiments; thus certain embodiments may be combinations of features of multiple embodiments.

Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

1. A method for replicating a broadcast:
receiving, from a device that generates two or more duplicate versions of a data stream that have the same content and different quality, a first version of the data stream with a relatively lower quality, and a second version of the data stream having a relatively higher quality, wherein the second version of the data stream is received from the device at a lower priority than the first version of the data stream;
editing the first version of a data stream received from each of a plurality of devices to generate a first version of an edited broadcast having the relatively lower quality; and
after editing the first version of the data stream, generating a second version of the edited broadcast replicating the first version of the edited broadcast, available only at a time delay after the first version of the edited broadcast, and with the relatively higher quality.

2. The method of claim 1 comprising broadcasting the first version of the edited broadcast in real-time.

3. The method of claim 1 comprising broadcasting the second version of the edited broadcast at a time delay postponed from when the broadcast content is recorded.

4. The method of claim 3, wherein receiving the second version of the data stream is postponed to increase the network traffic available to receive the first version of the data stream to thereby maximize the speed of displaying the first version of the edited broadcast including content from the first version of the data stream.

5. The method of claim 1 wherein the data size of the second version of the data stream is significantly larger than the first version of the data stream causing the second version of the data stream to be received at a relatively slower transfer speed than the first version of the data stream.

6. The method of claim 1, wherein
editing comprises generating an edit-log indexing timestamps of segments of the data stream to be included in the edited broadcast, and
generating the first and second versions of the edited broadcast comprises assembling the segments from the first and second version of the data streams, respectively, defined by their timestamps in the edit-log.

7. The method of claim 1, wherein the edited broadcast is edited using only the first, and not the second, version of the data stream.

8. The method of claim 1, wherein the second version of the data stream is received using a network protocol that is relatively more secure than that used to receive the first version of the data stream.

9. The method of claim 1, wherein the edited broadcast is a multi-frame broadcast simultaneously displaying, in different windows, segments from a plurality of data streams received from a plurality of respective devices.

10. The method of claim 1 comprising automatically replacing all instances of the first version of the edited broadcast with the second version of the edited broadcast.

11. A system for replicating a broadcast, the system comprising:
a processor configured to receive from each of a plurality of devices two or more duplicate versions of a data stream that have the same content and different quality, wherein a first version of the data stream has a relatively lower quality, and a second version of the data stream has a relatively higher quality, and wherein the second version of the data stream is received from the device at a lower priority than the first version of the data stream,
wherein the processor is configured to edit the first version of the data stream received from each of the plurality of devices to generate a first version of an edited broadcast having the relatively lower quality, and
wherein the processor is configured to generate a second version of the edited broadcast replicating the first version of the edited broadcast, available only at a time delay after the first version of the edited broadcast, and with the relatively higher quality; and
a memory to store the first or second version of the edited broadcast.

12. The system of claim 11, wherein the processor is configured to broadcast the first version of the edited broadcast in real-time.

13. The system of claim 11, wherein the processor is configured to broadcast the second version of the edited broadcast at a time delay postponed from when the broadcast content is recorded.

14. The system of claim 13, wherein the processor is configured to receive the second version of the data stream at a time later than receiving the first version of the data stream, to increase the network traffic available to receive the first version of the data stream and to thereby maximize the speed of displaying the first version of the edited broadcast including content from the first version of the data stream.

15. The system of claim 11, wherein the data size of the second version of the data stream is significantly larger than the data size of the first version of the data stream, causing the processor to receive the second version of the data stream at a relatively slower transfer speed than the first version of the data stream.

16. The system of claim 11, wherein the processor is configured to edit the broadcast by generating an edit-log indexing timestamps of segments of the data stream to be included in the edited broadcast, and wherein the processor is configured to generate the first and second versions of the edited broadcast by assembling the segments from the first and second version of the data streams, respectively, defined by the timestamps in the edit-log.

17. The system of claim 11, wherein the processor is configured to edit the edited broadcast using only the first version of the data stream.

18. The system of claim 11, wherein the processor is configured to receive the second version of the data stream using a network protocol that is relatively more secure than that used to receive the first version of the data stream.

19. The system of claim 11, comprising a display to display the edited broadcast as a multi-frame broadcast simultaneously displaying, in different windows, segments from a plurality of data streams received from a plurality of respective devices.

20. The system of claim 11, wherein the processor is configured to automatically replace all instances of the first version of the edited broadcast in the memory with the second version of the edited broadcast.

21. The system of claim 11, further comprising a plurality of devices capable of generating two or more duplicate versions of a data stream that have the same content and different quality, wherein said first version of the data stream has a relatively lower quality and said second version of the data stream has a relatively higher quality.

22. A method for replicating a broadcast, comprising:
generating two or more duplicate versions of a data stream that have the same content and different quality, a first version of the data stream with a relatively lower quality, and a second version of the data stream having a relatively higher quality;
sending the first version of the data stream to an editing device at a first priority to generate a first version of an edited broadcast having the relatively lower quality;
sending the second version of the data stream to the editing device, at a second priority lower than the first priority, to generate a second version of the edited broadcast replicating the first version of the edited broadcast, available only at a time delay after the first version of the edited broadcast, and with the relatively higher quality.

23. The method of claim 22 further comprising simultaneously recording the two or more duplicate versions of a data stream.

24. The method of claim 23 further comprising, after recording, storing the first version in a short-term memory to be immediately sent to the editing device, and storing the second version in a long-term memory.
